(19) United States
(12) Patent Application Publication
(10) Pub. No.: US 2026/0290810 A1
(43) Pub. Date: Sep. 24, 2026

(54) POSITIVE ELECTRODE ACTIVE MATERIAL FOR LITHIUM ION SECONDARY BATTERY, POSITIVE ELECTRODE FOR LITHIUM ION SECONDARY BATTERY AND LITHIUM ION SECONDARY BATTERY

(71) Applicant: HONDA MOTOR CO., LTD., Tokyo (JP)

(72) Inventors: Yuki CHIKAYASU, Saitama (JP); Takashi HAKARI, Saitama (JP); Yoshiyuki MORITA, Saitama (JP)

(21) Appl. No.: 19/555,978

(22) Filed: Mar. 4, 2026

(30) Foreign Application Priority Data
Mar. 24, 2025 (JP) 2025-047970

(51) Int. Cl. H01M 4/525; H01M 4/02; H01M 4/131; H01M 4/505; H01M 10/0525

(52) U.S. Cl. CPC H01M 4/525; H01M 4/131; H01M 4/505; H01M 10/0525; H01M 2004/028

(57) ABSTRACT

A positive electrode active material for a lithium ion secondary battery, the positive electrode active material containing a lithium nickel manganese composite oxide represented by Formula (1) described below, in which the lithium nickel manganese composite oxide has a crystal structure belonging to space group R-3m, and a peak intensity ratio I₍₀₀₃₎/I₍₁₀₄₎ of (003) plane peak to (104) plane peak in an XRD pattern of the lithium nickel manganese composite oxide satisfies 1.68≤I₍₀₀₃₎/I₍₁₀₄₎≤2.15,

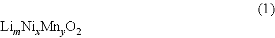

wherein, m is in a range of 1.0≤m≤1.06, x is in a range of 0.47≤x≤0.5, y is in a range of 0.47≤y≤0.5, and m+x+y=2.

### BACKGROUND

### Technical Field

The present invention relates to a positive electrode active material for a lithium ion secondary battery, a positive electrode for a lithium ion secondary battery, and a lithium ion secondary battery.

### Related Art

In recent years, research and development on a secondary battery that contributes to improvement of energy efficiency have been conducted. In particular, a lithium ion secondary battery is becoming increasingly important as a power source for an electric vehicle (EV), a hybrid electric vehicle (HEV), or the like.

A positive electrode active material has attracted attention as an important component for determining a capacity of a lithium ion secondary battery, and development thereof has been advanced. As a positive electrode active material for a lithium ion secondary battery, for example, a positive electrode active material containing a lithium composite oxide and a coating material with which a surface of the lithium composite oxide is coated, in which a peak intensity ratio I₍₀₀₃₎/I₍₁₀₄₎ of the (003) plane peak to the (104) plane peak in an XRD pattern of the lithium composite oxide satisfies a specific numerical range, has been reported (see, for example, JP 7228772 B2).

### CITATION LIST

### Patent Literature

Patent Literature 1: JP 7228772 B2

### SUMMARY

The positive electrode active material disclosed in JP 7228772 B2 allows for a battery with high energy density, but a material based on cobalt is used therein. The material based on cobalt is expensive and has been pointed out to be a resource risk.

Therefore, development of a material based on an element instead of cobalt is required.

However, a lithium ion secondary battery using a cobalt-free lithium composite oxide as a positive electrode active material exhibits a lower discharge capacity as compared with a conventional cobalt-based material or a high-nickel material containing a large amount of nickel, and there is room for improvement.

The present invention has been made to solve the above-described problems, and an object of the present invention is to provide a cobalt-free positive electrode active material for a lithium-ion secondary battery from which a lithium ion secondary battery capable of further increasing a discharge capacity can be obtained. In addition, the present invention also contributes to improvement of energy efficiency, accordingly.

In order to achieve the above-described object, the present invention provides the following configurations.

[1] A positive electrode active material for a lithium ion secondary battery, the positive electrode active material containing a lithium nickel manganese composite oxide represented by Formula (1) described below, wherein the lithium nickel manganese composite oxide has a crystal structure belonging to space group R-3m, and a peak intensity ratio I₍₀₀₃₎/I₍₁₀₄₎ of (003) plane peak to (104) plane peak in an XRD pattern of the lithium nickel manganese composite oxide satisfies 1.68≤I₍₀₀₃₎/I₍₁₀₄₎≤2.15,

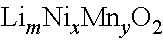

wherein, m is in a range of 1.0≤m≤1.06, x is in a range of 0.47≤x≤0.5, y is in a range of 0.47≤y≤0.5, and m+x+y=2.

In the positive electrode active material for a lithium ion secondary battery (hereinafter, also simply referred to as a “positive electrode active material”) according to [1], the peak intensity ratio I₍₀₀₃₎/I₍₁₀₄₎ of the (003) plane peak to the (104) plane peak in the XRD pattern using a Cu radiation source satisfies a specific numerical range. Here, I₍₀₀₃₎/I₍₁₀₄₎ is one of indices of cation mixing in the lithium nickel manganese composite oxide having a crystal structure belonging to the space group R-3m. Cation mixing refers to a phenomenon in which, due to the similarity in ionic radii between lithium ions (Li⁺) and nickel ions (Ni²⁺), Li⁺ and Ni²⁺ are substituted in the crystal structure, and Ni²⁺ occupies the Li site. As the ratio of cation mixing decreases, the I₍₀₀₃₎/I₍₁₀₄₎ ratio increases. As the ratio of cation mixing increases, the I₍₀₀₃₎/I₍₁₀₄₎ ratio decreases. In the lithium nickel manganese composite oxide used in the positive electrode active material described in [1], in a case where the I₍₀₀₃₎/I₍₁₀₄₎ ratio is more than 2.15, it is considered that the three-dimensional diffusion pathways of Li⁺ in the crystal structure are reduced by suppressing the cation mixing. As a result, the diffusibility of Li⁺ decreases, leading to a reduction in discharge capacity. In a case where the I₍₀₀₃₎/I₍₁₀₄₎ ratio is less than 1.68, disorder in the crystal structure increases, and the amount of Ni²⁺ in the Li site increases, so that the diffusion of Li⁺ in the Li site is inhibited. As a result, the diffusibility of Li⁺ decreases, leading to a reduction in discharge capacity. It is considered that since in the lithium nickel manganese composite oxide in the positive electrode active material described in [1], I₍₀₀₃₎/I₍₁₀₄₎ satisfies 1.68≤I₍₀₀₃₎/I₍₁₀₄₎≤2.15, cation mixing between Li⁺ and Ni²⁺ is controlled to an appropriate level. Accordingly, it is considered that the lithium nickel manganese composite oxide in the positive electrode active material described in [1] exhibits an increased number of three-dimensional diffusion pathways for Li⁺. Therefore, the lithium nickel manganese composite oxide in the positive electrode active material described in [1] is capable of improving the diffusibility of Li⁺ as compared to conventional positive electrode active materials. Therefore, the positive electrode active material according to [1] is suitable for achieving a high-capacity battery.

Therefore, the number of necessary batteries can be reduced, which contributes to cost reduction. That is, it is possible to contribute to improvement of energy efficiency.

[2] The positive electrode active material for a lithium ion secondary battery according to [1], wherein a half width of (110) plane peak in the XRD pattern of the lithium nickel manganese composite oxide is 0.17° or more and 0.51° or less.

In the positive electrode active material according to [2], the half width of the (110) plane peak in the XRD pattern is 0.17° or more and 0.51° or less. Accordingly, the lithium nickel manganese composite oxide in the positive electrode active material according to [2] has the appropriate crystallinity and crystallite size, which enables Li⁺ to diffuse more easily within primary particles, resulting in a reduction in resistance. Therefore, a discharge capacity of a lithium-ion secondary battery (hereinafter, also simply referred to as a “secondary battery”) can be even further increased. Therefore, it is possible to contribute to further improvement of energy efficiency.

[3] The positive electrode active material for a lithium ion secondary battery according to [1], wherein a half width of the (003) plane peak in the XRD pattern of the lithium nickel manganese composite oxide is 0.11° or more.

In the positive electrode active material according to [3], the half width of the (003) plane peak in the XRD pattern is 0.11° or more. Accordingly, the lithium nickel manganese composite oxide in the positive electrode active material according to [3] has the appropriate crystallinity and crystallite size, which enables Li⁺ to diffuse more easily within primary particles, resulting in a reduction in resistance. Therefore, a discharge capacity of the secondary battery can be even further increased.

Therefore, it is possible to contribute to further improvement of energy efficiency.

[4] A positive electrode for a lithium ion secondary battery, the positive electrode containing the positive electrode active material for a lithium ion secondary battery according to any one of [1] to [3].

The positive electrode for a lithium ion secondary battery according to [4] contains the positive electrode active material for a lithium ion secondary battery according to any one of [1] to [3]. This means that it is possible to improve the diffusibility of Lit. Accordingly, the positive electrode for a lithium ion secondary battery according to [4] is suitable for achieving a high-capacity battery.

[5] A lithium ion secondary battery including: a positive electrode; a negative electrode; and an electrolyte, wherein the positive electrode is the positive electrode for a lithium ion secondary battery according to [4].

The lithium ion secondary battery according to [5] includes the positive electrode for a lithium ion secondary battery described in [4]. This means that it is possible to improve the diffusibility of Li⁺. Therefore, the lithium ion secondary battery according to [5] is suitable for achieving high-capacity.

According to the positive electrode active material for a lithium ion secondary battery of the present invention, it is possible to further increase the discharge capacity of the cobalt-free lithium ion secondary battery.

### BRIEF DESCRIPTION OF DRAWINGS

FIG. 1 is a flowchart illustrating a method for manufacturing a positive electrode active material according to an embodiment of the present invention;

FIG. 2 is a diagram illustrating an XRD pattern of a positive electrode active material according to an embodiment of the present invention;

FIG. 3 is a cross-sectional view schematically illustrating a lithium ion secondary battery according to an embodiment of the present invention;

FIG. 4 is a graph illustrating a relationship between a peak intensity ratio I₍₀₀₃₎/I₍₁₀₄₎ of positive electrode active materials and a discharge capacity of the secondary batteries in Examples 1 to 7 and Comparative Examples 1 to 4;

FIG. 5 is a graph illustrating the relationship between a half width of the (110) plane peak of the positive electrode active materials and the discharge capacity of the secondary batteries in Examples 1 to 7 and Comparative Examples 1 to 4; and

FIG. 6 is a graph illustrating the relationship between a half width of the (003) plane peak of the positive electrode active materials and the discharge capacity of the secondary batteries in Examples 1 to 7 and Comparative Examples 1 to 4.

### DETAILED DESCRIPTION

Hereinafter, a preferred embodiment of the present invention will be described in detail.

### Positive Electrode Active Material for Lithium Ion Secondary Battery

The positive electrode active material for a lithium ion secondary battery according to the present embodiment (hereinafter, simply referred to as a “positive electrode active material”) is a cobalt-free positive electrode active material containing a lithium nickel manganese composite oxide. Here, the term “cobalt-free” means that the lithium nickel manganese composite oxide does not contain cobalt at all or inevitably contains a slight amount of cobalt.

As long as the function of the present invention is not impaired, the positive electrode active material may contain components other than the lithium nickel manganese composite oxide.

The positive electrode active material of the present embodiment may include only one kind or two or more kinds of lithium nickel manganese composite oxides.

When a lithium nickel manganese composite oxide is manufactured as a positive electrode active material, the composition ratio (Li:Ni:Mn) of the entire lithium nickel manganese composite oxide is also maintained in the obtained positive electrode active material. In addition, the composition ratio of the lithium nickel manganese composite oxide is adjusted so as to be similar to the composition ratio required for the positive electrode active material to be obtained.

Lithium Nickel Manganese Composite Oxide The lithium nickel manganese composite oxide according to the present embodiment has a layered rock salt structure and is in the form of particles. The lithium nickel manganese composite oxide has a crystal structure belonging to the space group R-3m.

In the present specification, the average particle diameter of the particles of the lithium nickel manganese composite oxide (hereinafter, also simply referred to as “average particle diameter”) is not particularly limited, but is, for example, preferably 0.25 to 10 μm, more preferably 0.25 to 5.0 μm, and still more preferably 0.50 to 4.0 μm. When the average particle diameter is the above-described lower limit value or more, the productivity of the positive electrode active material can be further increased. When the average particle diameter is the above-described upper limit value or less, the electrochemical characteristics of the lithium ion secondary battery can be further improved.

The average particle diameter means, for example, D50 measured by a laser diffraction particle diameter distribution measuring apparatus or the like.

### Chemical Composition

The lithium nickel manganese composite oxide of the present embodiment is represented by the following Formula (1).

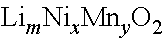

In Formula (1), m is in a range of 1.0≤m≤1.06, x is in a range of 0.47≤x≤0.5, y is in a range of 0.47≤y≤0.5, and m+x+y=2.

In formula (1), m, x, and y represent the molar ratios of Li, Ni, and Mn, respectively. That is, the molar ratio among Li, Ni, and Mn is m:x:y.

The lithium nickel manganese composite oxide of the present embodiment more preferably has m in a range of 1.02≤m≤1.04, x in a range of 0.48≤x≤0.49, and y in a range of 0.48≤y≤0.49 in Formula (1). Specifically, the lithium nickel manganese composite oxide used in the present invention has a chemical composition ranging from Li_{1.02}Ni_{0.49}Mn_{0.49}O₂ to Li_{1.04}Ni_{0.48}Mn_{0.48}O₂.

The chemical composition of the lithium nickel manganese composite oxide of the present embodiment can be determined by inductively coupled plasma (ICP) emission spectrometry.

The particles of the lithium nickel manganese composite oxide of the present embodiment may be primary particles or secondary particles. The particle of the lithium nickel manganese composite oxide is preferably a secondary particle in which a plurality of primary particles are aggregated with each other from a viewpoint that relatively dense particles can be obtained.

In the lithium nickel manganese composite oxide of the present embodiment, the peak intensity ratio I₍₀₀₃₎/I₍₁₀₄₎ of the (003) plane peak to the (104) plane peak in the X-ray diffraction (XRD) pattern using a Cu radiation source satisfies 1.68≤I₍₀₀₃₎/I₍₁₀₄₎≤2.15. The peak intensity ratio I₍₀₀₃₎/I₍₁₀₄₎ is preferably 1.75≤I₍₀₀₃₎/I₍₁₀₄₎≤2.15, and more preferably 1.78≤I₍₀₀₃₎/I₍₁₀₄₎≤2.15. When the peak intensity ratio I₍₀₀₃₎/I₍₁₀₄₎ is equal to or more than the lower limit value described above, disorder in the crystal structure is reduced, the amount of Ni²⁺ in the Li sites decreases, and as a result, the diffusion of Li⁺ within the Li sites is not inhibited; thereby, a decrease in discharge capacity can be suppressed. When the peak intensity ratio I₍₀₀₃₎/I₍₁₀₄₎ is equal to or less than the upper limit value, cation mixing is controlled to an appropriate level, and a decrease in the three-dimensional diffusion pathways of Li⁺ can be suppressed. Therefore, the diffusion of Li⁺ is not inhibited, and a decrease in discharge capacity can be suppressed.

The peak intensity ratio I₍₀₀₃₎/I₍₁₀₄₎ is determined by analyzing an XRD pattern. Here, the peak intensity I₍₀₀₃₎ refers to the peak height of the (003) plane peak in the XRD pattern of the lithium nickel manganese composite oxide in the space group R-3m. The peak intensity I₍₁₀₄₎ refers to the peak height of the (104) plane peak in the XRD pattern of the lithium nickel manganese composite oxide in the space group R-3m.

The half width of the (110) plane peak in the XRD pattern of the lithium nickel manganese composite oxide is preferably 0.17° or more and 0.51° or less, and more preferably 0.185° or more and 0.51° or less. When the half width of the (110) plane peak is within the above-described numerical range, the lithium nickel manganese composite oxide has the appropriate crystallinity and crystallite size, which enables Li⁺ to diffuse more easily within primary particles, resulting in a reduction in resistance. Therefore, a discharge capacity of the secondary battery can be further increased.

The half width of the (110) plane peak is determined by analyzing the XRD pattern.

The half width of the (003) plane peak in the XRD pattern of the lithium nickel manganese composite oxide is preferably 0.11° or more, more preferably 0.12° or more, and still more preferably 0.123° or more. When the half width of the (003) plane peak is equal to or more than the above-described lower limit value, the lithium nickel manganese composite oxide has the appropriate crystallinity and crystallite size, which enables Li⁺ to diffuse more easily within primary particles, resulting in a reduction in resistance. Therefore, a discharge capacity of the secondary battery can be further increased. The upper limit value of the half width of the (003) plane peak is not particularly limited, but is preferably, for example, 0.15°.

The half width of the (003) plane peak is determined by analyzing the XRD pattern.

The lithium nickel manganese composite oxide of the present embodiment can control the peak intensity ratio I₍₀₀₃₎/I₍₁₀₄₎ and the half width of the (110) and (003) plane peaks in the XRD pattern by adjusting the heat treatment conditions. The heat treatment conditions are appropriately set to obtain the lithium nickel manganese composite oxide of the present embodiment. Although the optimal conditions for heat treatment depend on other manufacturing conditions, the higher the heat treatment temperature and the longer the heat treatment time, the smaller the peak intensity ratio I₍₀₀₃₎/I₍₁₀₄₎ tends to be, and the degree of cation mixing tends to increase. Furthermore, the half width of the (110) plane peak tends to decrease and the crystallinity tends to increase. As a result, the discharge capacity decreases.

### Method for Manufacturing Positive Electrode Active Material

The positive electrode active material of the present embodiment contains the above-described lithium nickel manganese composite oxide. As a lithium source of the lithium nickel manganese composite oxide, a known lithium compound such as a hydroxide such as lithium hydroxide monohydrate (LiOH·H₂O), a carbonate such as lithium carbonate (Li₂CO₃), or an acetate such as lithium acetate (CH₃COOLi) and lithium acetate dihydrate (CH₃COOLi·2H₂O) can be used, and are not particularly limited. In the compounds of the nickel source and the manganese source of the transition metal, known oxides, hydroxides, or metal salts of nickel and manganese can be widely used, and are not particularly limited.

For example, as the nickel compound, nickel hydroxide (Ni(OH)₂), nickel (II) chloride (NiCl₂), nickel (II) chloride hexahydrate (NiCl₂·6H₂O), nickel (II) nitrate hexahydrate (Ni(NO₃)₂·6H₂O), and the like can be used, but the nickel compound is not limited thereto.

As the manganese compound, manganese (II) chloride (MnCl₂), manganese (II) chloride tetrahydrate (MnCl₂·4H₂O), manganese carbonate hexahydrate (MnCO₃·6H₂O), manganese (II) nitrate hexahydrate (Mn(NO₃)₂. 6H₂O) and the like can be used, but the manganese compound is not limited thereto. The transition metal compounds can be used not only singly but also as a composite hydroxide (for example, nickel-manganese composite hydroxides) or the like by using a coprecipitation method or the like.

### Preparation of Lithium Nickel Manganese Composite Oxide

In the preparation of the lithium nickel manganese composite oxide, first, a predetermined amount of a lithium compound is added to the nickel-manganese compound of the intermediate, and the mixture is dispersed in a solvent such as ethanol and mixed. A predetermined amount of the intermediate compound and a predetermined amount of the lithium compound may be mixed not only by wet mixing using a solvent but also by dry mixing not using a solvent. For example, in a case of synthesizing Li_{1.04}Ni_{0.48}Mn_{0.48}O₂ by using lithium hydroxide monohydrate (LiOH·H₂O) as a lithium compound, LiOH·H₂O is preferably weighed more than the stoichiometric ratio by 1% by mass to 5% by mass, for example, 1.5% by mass.

The nickel-manganese compound can be synthesized by a known method. In a case where the nickel-manganese compound is a hydroxide, for example, nickel sulfate hexahydrate (NiSO₄·6H₂O) and manganese sulfate pentahydrate (MnSO₄·5H₂O) are weighed so that a molar ratio of Ni:Mn becomes 1:1, pure water is added thereto to dissolve the compounds, and an aqueous alkali solution is added dropwise to the aqueous sulfate solution, and thereby the compounds can be coprecipitated as a nickel-manganese composite hydroxide.

The lithium nickel manganese composite oxide of the present embodiment can be synthesized using a known method. For example, the synthesis can be performed as follows: a composite hydroxide or a composite oxide of a nickel compound and a manganese compound is prepared as an intermediate compound, the intermediate compound and a lithium compound are mixed to obtain a raw material mixture, and the raw material mixture is heat-treated (for example, fired) at a predetermined temperature for a predetermined time in a predetermined atmosphere.

A mixture of a lithium compound and a nickel-manganese compound as a precursor is pulverized into a preferable size, mixed, and then filled in a crucible or the like, and the mixture is heat-treated. As the crucible, an alumina sagger, an alumina crucible, a platinum crucible, a gold crucible, or the like is used. In the heat treatment of the mixture, for example, a firing furnace or a roller hearth kiln is used.

The mixture put into the sagger or the crucible is heated to reach a heat treatment temperature at a temperature-rising rate of 5° C./min to 25° C./min, and preferably 10° C./min to 25° C./min. A heat treatment atmosphere is not particularly limited, and examples thereof include the atmosphere (under an air atmosphere), an oxygen flow, and the like. The heat treatment atmosphere is preferably an oxygen flow. A heat treatment time can be appropriately set according to a heat treatment temperature. Note that the heat treatment time means time for holding the heat treatment temperature.

By the above-described method, a lithium nickel manganese composite oxide is obtained.

Hereinafter, a method for manufacturing the positive electrode active material of the present embodiment will be described in detail with reference to the drawings.

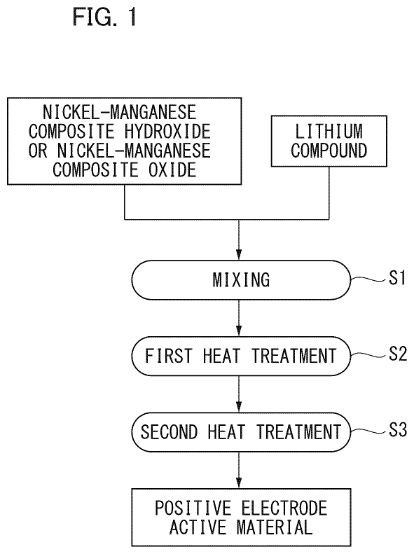

FIG. 1 illustrates a flowchart of a method for manufacturing a positive electrode active material of the present embodiment.

As illustrated in FIG. 1, the method for manufacturing a positive electrode active material of the present embodiment includes a mixing step (S1), a first heat treatment step (S2), and a second heat treatment step (S3).

### Mixing Step (S1)

The mixing step (S1) is a step of mixing a nickel-manganese composite hydroxide or a nickel-manganese composite oxide (intermediate compound) with a lithium compound to obtain a raw material mixture.

A known mixer can be used for mixing the intermediate compound and the lithium compound.

Examples of such a mixer include a shaker mixer, a Loedige mixer, a Julia mixer, and a V blender.

Mixing conditions in the mixing step are not particularly limited, but it is preferable to select conditions such that components serving as raw materials are sufficiently mixed to an extent that the shapes of particles and the like of the raw materials such as the intermediate compound are not broken.

The treatment time (stirring time) in the mixing step is not particularly limited, but is preferably, for example, 10 minutes to 60 minutes.

The treatment temperature in the mixing step is not particularly limited, but is preferably, for example, 5° C. to 30° C.

### First Heat Treatment Step (S2)

The first heat treatment step (S2) is a step of heat-treating (hereinafter, also referred to as “pre-firing”) the raw material mixture obtained in the mixing step at a predetermined temperature for a predetermined time in a predetermined atmosphere. In the first heat treatment step, for example, firing is performed at 650° C. or higher and 900° C. or lower for 10 minutes or more and 6 hours or less. In the first heat treatment step, a firing furnace or a roller hearth kiln can be used. The firing atmosphere in the first heat treatment step is not particularly limited, and examples thereof include an atmosphere (under air atmosphere) and an oxygen flow. The firing atmosphere is preferably the oxygen flow.

The firing temperature in the first heat treatment step (hereinafter, also referred to as “first heat treatment temperature”) is, for example, preferably 650° C. or higher and 900° C. or lower, and more preferably 750° C. or higher and 850° C. or lower.

The firing time in the first heat treatment step (hereinafter, also referred to as “first heat treatment time”) is, for example, preferably 10 minutes or more and 6 hours or less, more preferably 20 minutes or more and 4 hours or less, still more preferably 30 minutes or more and 2 hours or less, and particularly preferably 30 minutes or more and 1 hour or less.

### Second Heat Treatment Step (S3)

The second heat treatment step (S3) is a step of heating the mixture obtained in the first heat treatment step at a temperature higher than the first heat treatment temperature and firing (hereinafter, also referred to as “main firing”) the mixture. In the second heat treatment step, for example, firing is performed at 950° C. or higher and 1100° C. or lower for 5 minutes or more and 4 hours or less. In the second heat treatment step, a firing furnace or a roller hearth kiln similar to that in the first heat treatment step can be used. The firing atmosphere in the second heat treatment step is not particularly limited, and can be the same firing atmosphere as in the first heat treatment step.

The firing temperature in the second heat treatment step (hereinafter, also referred to as “second heat treatment temperature”) is, for example, preferably 950° C. or higher and 1100° C. or lower, and more preferably 975° C. or higher and 1050° C. or lower.

The firing time in the second heat treatment step (hereinafter, also referred to as “second heat treatment time”) is, for example, preferably 5 minutes or more and 4 hours or less, more preferably 10 minutes or more and 3 hours or less, still more preferably 15 minutes or more and 2 hours or less, and particularly preferably 30 minutes or more and 1 hour or less.

By appropriately controlling the second heat treatment temperature and the second heat treatment time in the second heat treatment step, a lithium nickel manganese composite oxide in which the peak intensity ratio I₍₀₀₃₎/I₍₁₀₄₎ in the XRD pattern satisfies 1.68≤I₍₀₀₃₎/I₍₁₀₄₎≤2.15 is obtained.

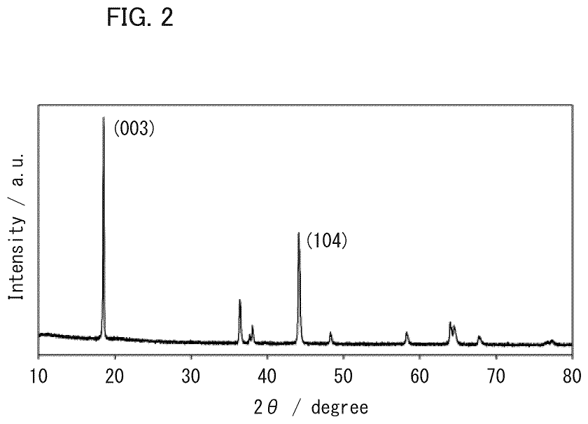

FIG. 2 illustrates an XRD pattern of the positive electrode active material of Example 2 described later. As illustrated in FIG. 2, the peak intensity ratio I₍₀₀₃₎/I₍₁₀₄₎ in the XRD pattern of the positive electrode active material of Example 2 is 2.012.

Through the above-described steps, a positive electrode active material containing the lithium nickel manganese composite oxide of the present embodiment is obtained.

### Lithium Ion Secondary Battery

The lithium ion secondary battery of the present embodiment includes a positive electrode, a negative electrode, and an electrolyte, and the positive electrode (also referred to as a “positive electrode for a lithium ion secondary battery”) contains a positive electrode active material containing the above-described lithium nickel manganese composite oxide as a main component. The lithium ion secondary battery of the present embodiment may include other battery elements as necessary.

In the lithium ion secondary battery of the present embodiment, a battery element of a known lithium ion secondary battery can be adopted as it is except that the positive electrode contains a positive electrode active material containing the above-described lithium nickel manganese composite oxide. The lithium ion secondary battery of the present embodiment may have any of a coin type, a button type, a cylindrical type, a square type, and a laminate type. In addition, the lithium ion secondary battery of the present embodiment can be applied to a wide range of applications such as a mobile device such as a mobile phone or a laptop computer, and in-vehicle applications.

Hereinafter, as for the lithium ion secondary battery of the present embodiment, a lithium ion secondary battery (coin-type lithium ion secondary battery) using an electrolytic solution will be described.

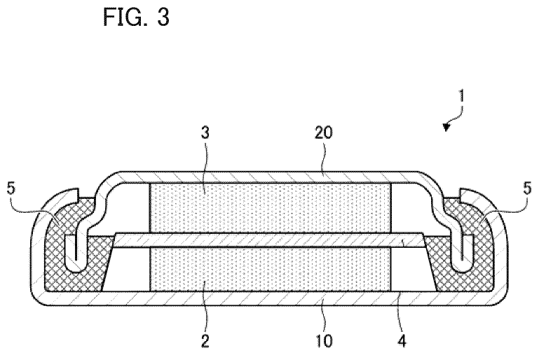

FIG. 3 is a cross-sectional view schematically illustrating a lithium ion secondary battery according to the present embodiment. FIG. 3 illustrates an example in which the lithium ion secondary battery of the present embodiment is a coin-type lithium ion secondary battery. As illustrated in FIG. 3, a lithium ion secondary battery 1 of the present embodiment includes a negative electrode can (negative electrode terminal) 20, a negative electrode 3, a separator 4 impregnated with an electrolytic solution, an insulating packing (gasket) 5, a positive electrode 2, and a positive electrode can 10.

The positive electrode can 10 is disposed on a lower side of the separator 4, the negative electrode can 20 is disposed on an upper side of the separator 4, and an outer shape of the lithium ion secondary battery 1 is formed by the positive electrode can 10 and the negative electrode can 20. The positive electrode 2 and the negative electrode 3 are disposed between the positive electrode can 10 and the negative electrode can 20 with the separator 4 impregnated with an electrolytic solution interposed therebetween, and the positive electrode 2 and the negative electrode 3 are separated from each other by the separator 4. The positive electrode can 10 and the negative electrode can 20 are electrically insulated from each other by the insulating packing 5.

In the lithium ion secondary battery 1, the positive electrode 2 can be prepared by blending a conductive agent, a binder, and the like with the positive electrode active material of the present embodiment as necessary to prepare a positive electrode mixture, and pressing the positive electrode mixture to a current collector (not illustrated).

As the current collector, a stainless steel mesh, an aluminum foil, or the like can be preferably used. As the conductive agent, acetylene black, ketjen black, or the like can be preferably used. As the binder, tetrafluoroethylene, polyvinylidene fluoride, or the like can be preferably used.

Blending of the positive electrode active material, the conductive agent, and the binder in the positive electrode mixture is not particularly limited. The content of the conductive agent in the positive electrode mixture is preferably 0.1% by mass to 15% by mass, and more preferably 0.18 by mass to 5% by mass. The content of the binder in the positive electrode mixture is preferably 0.1% by mass to 10% by mass, and more preferably 0.1% by mass to 5% by mass. It is preferable to blend the positive electrode active material, the conductive agent, and the binder such that a remainder (a portion other than the binder and the conductive agent) in the positive electrode mixture is the positive electrode active material.

In the lithium ion secondary battery 1, as the negative electrode 3 with respect to the positive electrode 2, a known electrode that functions as a negative electrode active material and can intercalate and release lithium, for example, a metal-based material such as metallic lithium or a lithium alloy, a carbon-based material such as graphite or mesocarbon microbeads (MCMB), or a silicon-based material such as silicon (Si), a Si alloy, or silicon oxide can be adopted.

Known battery elements can be adopted as the separator 4 and the battery containers (positive electrode can 10 and negative electrode can 20).

As the electrolyte, a known electrolytic solution or the like can be employed. As the electrolytic solution, for example, a solution obtained by dissolving an electrolyte such as lithium perchlorate or lithium hexafluorophosphate in a solvent such as ethylene carbonate (EC), dimethyl carbonate (DMC), propylene carbonate (PC), or diethyl carbonate (DEC) can be used.

In the lithium ion secondary battery 1 of the present embodiment, since the positive electrode 2 contains a positive electrode active material containing the above-described lithium nickel manganese composite oxide as a main component, it is possible to achieve high capacity.

### EXAMPLES

Next, examples of the present invention will be described, but the present invention is not limited to the examples below.

### Example 1

Preparation of Lithium Nickel Manganese Composite Oxide: Li_{1.04}Ni_{0.48}Mn_{0.48}O₂

LiOH·H₂O and Ni_{0.5}Mn_{0.5}(OH)₂ were weighed so that Li:Ni:Mn=1.04:0.48:0.48 in terms of molar ratio, and in consideration of Li evaporation, LiOH·H₂O was weighed so as to be increased by 1.5% by mass based on the stoichiometric ratio. The total mass of LiOH·H₂O and Ni_{0.5}Mn_{0.5}(OH)₂ was set to 10 g. These were mixed by dry mixing (mixing step). Thereafter, a platinum crucible was filled. The raw material mixture filled in the platinum crucible was heated by using a firing furnace in the air at a temperature-rising rate of 10° C./min and subjected to preliminary firing at 850° C. for 60 minutes (first heat treatment step), and the obtained powder was then left to stand until the temperature of the powder reached room temperature (25° C.). Thereafter, the obtained powder was heated at a temperature-rising rate of 10° C./min, and subjected to main firing at 975° C. for 30 minutes (second heat treatment step). After the main firing, the resulting powder was left to stand until the temperature reached room temperature (25° C.) to prepare a lithium nickel manganese composite oxide.

### Example 2

Except that the second heat treatment temperature was 1000° C., the same procedure as in Example 1 was carried out to prepare a lithium nickel manganese composite oxide.

### Example 3

Except that the second heat treatment temperature was 1025° C., the same procedure as in Example 1 was carried out to prepare a lithium nickel manganese composite oxide.

### Example 4

Except that the second heat treatment temperature was 950° C. and the second heat treatment time was 15 minutes, the same procedure as in Example 1 was carried out to prepare a lithium nickel manganese composite oxide.

### Example 5

Except that the second heat treatment temperature was 1000° C. and the second heat treatment time was 15 minutes, the same procedure as in Example 1 was carried out to prepare a lithium nickel manganese composite oxide.

### Example 6

Except that the second heat treatment temperature was 1050° C. and the second heat treatment time was 15 minutes, the same procedure as in Example 1 was carried out to prepare a lithium nickel manganese composite oxide.

### Example 7

Except that the second heat treatment temperature was 1000° C. and the second heat treatment time was 60 minutes, the same procedure as in Example 1 was carried out to prepare a lithium nickel manganese composite oxide.

### Comparative Example 1

Except that the second heat treatment temperature was 950° C., the same procedure as in Example 1 was carried out to prepare a lithium nickel manganese composite oxide.

### Comparative Example 2

Except that the second heat treatment temperature was 1050° C., the same procedure as in Example 1 was carried out to prepare a lithium nickel manganese composite oxide.

### Comparative Example 3

Except that the second heat treatment temperature was 1075° C., the same procedure as in Example 1 was carried out to prepare a lithium nickel manganese composite oxide.

### Comparative Example 4

Except that the second heat treatment temperature was 1050° C. and the second heat treatment time was 60 minutes, the same procedure as in Example 1 was carried out to prepare a lithium nickel manganese composite oxide.

### Preparation of Lithium Ion Secondary Battery

Lithium nickel manganese composite oxides of Examples 1 to 7 and Comparative Examples 1 to 4 were used as a positive electrode active material, acetylene black (AB) was used as a conductive agent, polyvinylidene fluoride (PVDF) was used as a binder, and N-methyl-2-pyrrolidone (NMP) was used as a solvent at a weight ratio of 96:2:2 to prepare a slurry. Thereafter, an aluminum foil having a thickness of 15 μm was coated with the slurry and was dried to prepare a positive electrode having a diameter of 14 φ. A coating area density was set to 20 mg/cm², and a volume density was set to 3.0 g/cm³. With respect to the positive electrode, a lithium metal having a thickness of 300 μm and a diameter of 16 φ was used as a counter electrode, and a polyethylene microporous film having a thickness of 14 μm and a diameter of 19.4 φ was used as a separator. A 1.2 mol/L solution obtained by dissolving lithium hexafluorophosphate (LiPF₆) in a mixed solvent of ethylene carbonate (EC), dimethyl carbonate (DMC), and ethyl methyl carbonate (EMC) (volume ratio: 3:4:3) was used as an electrolytic solution, and a lithium-ion secondary battery (2032 coin-type cell) having the structure illustrated in FIG. 3 was prepared. The battery was prepared according to a known cell configuration and assembly method.

### Charge and Discharge Test

Each of the produced lithium ion secondary batteries was subjected to a charge and discharge test at a constant current at a rate of 0.33 C (1C: 200 mA/g), a current density of 66.7 mA/g, a cutoff potential of 4.3 V to 2.65 V under a temperature condition of 25° C. to evaluate an initial discharge capacity. The charge and discharge test was started from charge. Results thereof are presented in Table 1.

TABLE 1

| | Second heat | Second heat | Peak | Half width | Half width | Half width | |
|---|---|---|---|---|---|---|---|
| | treatment | treatment | intensity | of (003) | of (104) | of (110) | Discharge |
| | temperature | time | ratio ratio | plane | plane | plane | capacity |
| | (° C.) | (min) | I₍₀₀₃₎/I₍₁₀₄₎ | (°) | (°) | (°) | (mAh/g) |
| Example 1 | 975 | 30 | 2.001 | 0.1300 | 0.2800 | 0.343 | 152.91 |
| Example 2 | 1000 | 30 | 2.012 | 0.1451 | 0.2683 | 0.295 | 154.29 |
| Example 3 | 1025 | 30 | 1.787 | 0.1234 | 0.2339 | 0.185 | 154.21 |
| Example 4 | 950 | 15 | 2.137 | 0.1297 | 0.3460 | 0.510 | 155.20 |
| Example 5 | 1000 | 15 | 1.976 | 0.1278 | 0.2745 | 0.283 | 152.48 |
| Example 6 | 1050 | 15 | 1.685 | 0.1161 | 0.2252 | 0.181 | 153.16 |
| Example 7 | 1000 | 60 | 1.904 | 0.1254 | 0.2624 | 0.230 | 153.22 |
| Comparative | 950 | 30 | 2.188 | 0.1324 | 0.3215 | 0.529 | 150.09 |
| Example 1 | | | | | | | |
| Comparative | 1050 | 30 | 1.324 | 0.1400 | 0.2228 | 0.161 | 151.09 |
| Example 2 | | | | | | | |
| Comparative | 1075 | 30 | 1.463 | 0.0880 | 0.1953 | 0.146 | 141.06 |
| Example 3 | | | | | | | |
| Comparative | 1050 | 60 | 1.661 | 0.0946 | 0.2027 | 0.140 | 150.94 |
| Example 4 | | | | | | | |

As illustrated in Table 2, the peak intensity ratio I₍₀₀₃₎/I₍₁₀₄₎ of the positive electrode active materials of Examples 1 to 7 satisfied 1.68≤I₍₀₀₃₎/I₍₁₀₄₎≤2.15, whereas the peak intensity ratio I₍₀₀₃₎/I₍₁₀₄₎ of the positive electrode active materials of Comparative Examples 1 to 4 was less than 1.68 or more than 2.15. The half width of the (110) plane peak of the positive electrode active materials of Examples 1 to 7 satisfied 0.17° or more and 0.51° or less, whereas the half width of the (110) plane peak of the positive electrode active materials of Comparative Examples 1 to 4 was less than 0.17° or more than 0.51°.

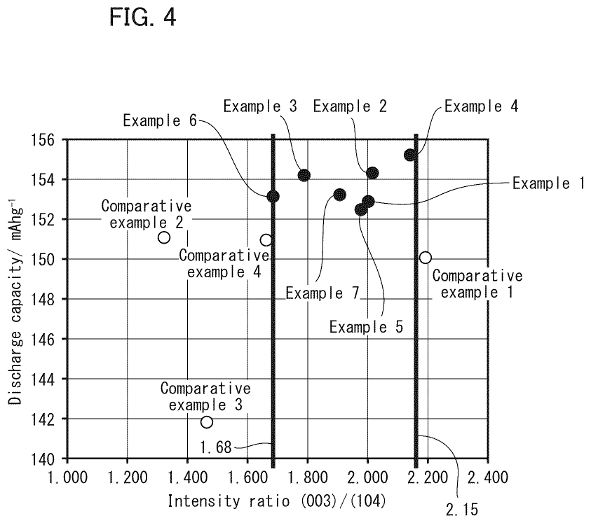

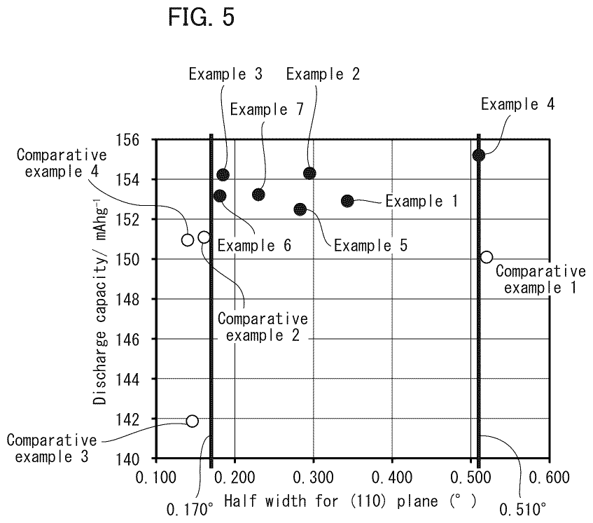

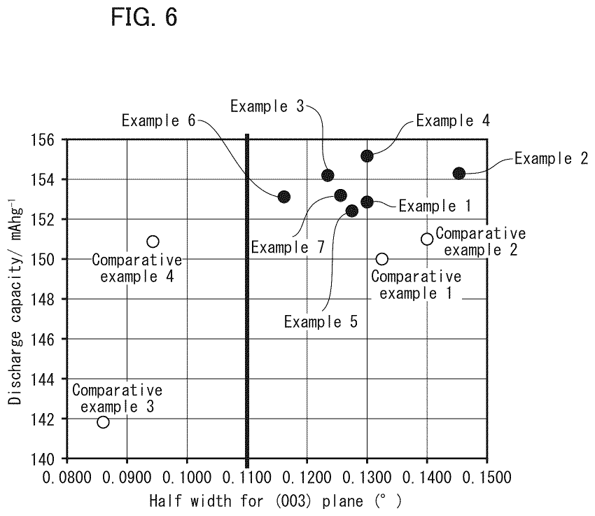

The results of Table 2 are illustrated in FIGS. 4 to 6.

As illustrated in FIGS. 4 to 6, it was found that the positive electrode active materials of Examples 1 to 7 have a high discharge capacity of 152.0 mAh/g or more, and the discharge capacity can be further increased as compared with the positive electrode active materials of Comparative Examples 1 to 4.

From the above-described results, it was found that according to the present invention, it is possible to provide a cobalt-free positive electrode active material for a lithium ion secondary battery capable of further increasing the discharge capacity.

This is considered to be because by appropriately controlling the peak intensity ratio I₍₀₀₃₎/I₍₁₀₄₎, an appropriate degree of cation mixing is achieved, and the diffusibility of Li⁺ was improved. From this, it is considered that battery performance equivalent to that of a positive electrode material containing cobalt or a positive electrode material of high nickel containing a large amount of Ni can be achieved, and cost reduction can be realized.

What is claimed is:

1. A positive electrode active material for a lithium ion secondary battery, the positive electrode active material comprising a lithium nickel manganese composite oxide represented by Formula (1) described below, wherein
the lithium nickel manganese composite oxide has a crystal structure belonging to space group R-3m, and
a peak intensity ratio I₍₀₀₃₎/I₍₁₀₄₎ of (003) plane peak to (104) plane peak in an XRD pattern of the lithium nickel manganese composite oxide satisfies 1.68≤I₍₀₀₃₎/I₍₁₀₄₎≤2.15, 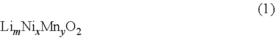
wherein, m is in a range of 1.0≤m≤1.06, x is in a range of 0.47≤x≤0.5, y is in a range of 0.47≤y≤0.5, and m+x+y=2.

2. The positive electrode active material for a lithium ion secondary battery according to claim 1, wherein a half width of (110) plane peak in the XRD pattern of the lithium nickel manganese composite oxide is 0.17° or more and 0.51° or less.

3. The positive electrode active material for a lithium ion secondary battery according to claim 1, wherein a half width of the (003) plane peak in the XRD pattern of the lithium nickel manganese composite oxide is 0.11° or more.

4. A positive electrode for a lithium ion secondary battery, the positive electrode comprising the positive electrode active material for a lithium ion secondary battery according to claim 1.

5. A lithium ion secondary battery comprising: a positive electrode; a negative electrode; and an electrolyte, wherein the positive electrode is the positive electrode for a lithium ion secondary battery according to claim 4.
